(19) United States
(12) Patent Application Publication
(10) Pub. No.: US 2025/0116113 A1
(43) Pub. Date: Apr. 10, 2025

(54) APPARATUS FOR MODULATING FLOW FROM A DOWNSPOUT

(71) Applicant: Erosion Control Central Ltd., Calgary (CA)

(72) Inventor: James Douglas McCaw, Calgary (CA)

(21) Appl. No.: 18/907,190

(22) Filed: Oct. 4, 2024

Related U.S. Application Data
(60) Provisional application No. 63/587,944, filed on Oct. 4, 2023.

(51) Int. Cl. E04D 13/08; F15D 1/02

(52) U.S. Cl. CPC E04D 13/08; F15D 1/025; E04D 2013/0813

(57) ABSTRACT

An apparatus for modulating flow from a downspout is provided. The apparatus comprises a first layer that is releasably connectible proximal to a point of egress from the downspout, the first layer having a first opening and defining an internal plenum, and wherein the apparatus is configured to modulate at least a portion of the flow while receivably passing the flow therethrough.

### CROSS-REFERENCE TO RELATED APPLICATION

This application claims the benefit of priority from U.S. Provisional Patent Application Ser. No. 63/587,944 filed on Oct. 4, 2023, the entire contents of which are incorporated herein by reference.

### TECHNICAL FIELD

The present disclosure generally relates to modulating flow. In particular, the disclosure relates to an apparatus, system, and method for modulating flow from a downspout.

### BACKGROUND

Rain events cause water to exit eaves, troughs, and downspouts in a concentrated flow with high rates of flow. This concentrated flow can erode clay and topsoil on the ground, and carry sediment onto sidewalks, curbs, asphalt, or storm water catch basins.

Sediment is considered a deleterious substance and the discharge of sediment-laden water into storm water infrastructure is not legally permitted in many jurisdictions. Further, cleaning erosion can be costly, especially during the stripping and grading process of home construction when the surrounding lands are particularly vulnerable to erosion. Addressing this issue requires innovative and specialized approaches to overcome the difficulties associated with erosion from flow.

As such, it may be desirable to provide new approaches for apparatuses, systems, and methods that address some of the shortcomings of known solutions for reducing the negative impact of flow from a downspout.

### SUMMARY

Some embodiments of the present disclosure relates to an apparatus for modulating flow from a downspout. The apparatus comprises a first layer having a first end that is releasably connectible proximal a point of egress from the downspout and first layer also defines an internal plenum. The apparatus is configured to modulate at least a portion of the flow while receivably passing the flow therethrough.

In some embodiments, the apparatus comprises a first matrix at least partially housed within the internal plenum, the first matrix comprising a first material that is configured to absorb at least a portion of the flow. In some embodiments, the apparatus comprises a rigid material.

Some embodiments of the present disclosure relate to a method for modulating flow from a downspout. The method comprises a step of providing an apparatus comprising a first layer and a step of releasably connecting the apparatus proximal to an egress point of the downspout. The method further includes a step of modulating the flow received from the downspout as it passes through the apparatus.

Without being bound by any particular theory, the embodiments of the present disclosure may provide an approach to reduce erosion through modulating the concentrated flow that egresses a downspout. For example, the embodiments of the present disclosure may reduce or prevent sediment from being carried by rainwater into storm water infrastructure including catch basins, concrete drainage swales, curbs, and storm ponds, or into environmental reserves including wetlands, swamps, gully's, ravines, coulees, and natural drainage courses. Some embodiments of the present disclosure may overcome the drawbacks of known reducers of flow from downspouts while providing an entirely environmentally friendly solution that is compostable and/or biodegradable.

### BRIEF DESCRIPTION OF THE DRAWINGS

These and other features of the present disclosure will become more apparent in the following detailed description in which reference is made to the appended drawings.

FIG. 1 is a side view of an apparatus for modulating a flow rate of effluent from a downspout, according to some embodiments of the present disclosure, wherein the apparatus comprises a first matrix for receivably passing flow from the downspout.

FIG. 2 is a cross-sectional side view of the apparatus shown in FIG. 1.

FIG. 3 is a cross-sectional front view of the apparatus shown in FIG. 1.

FIG. 4 shows an exemplary first layer containing a first matrix of the present disclosure.

FIG. 5 is a perspective view of another apparatus for modulating a flow rate of effluent from a downspout, according to some embodiments of the present disclosure, wherein the apparatus comprises a first matrix for receivably passing flow from the downspout.

FIG. 6 is a flowchart showing the steps of a method for modulating a flow rate of an effluent from a downspout, according to some embodiments of the present disclosure.

FIG. 7 shows top perspective views of another apparatus for modulating a flow rate of effluent from a downspout, according to some embodiments of the present disclosure, wherein the apparatus comprises a rigid material. FIGS. 7A, 7B, 7C, and 7D show different embodiments of the apparatus.

FIG. 8 is a side perspective view of an end cap of the apparatus shown in FIG. 7.

### DETAILED DESCRIPTION

The embodiments of the present disclosure relate to an apparatus for modulating flow from a downspout and a method for modulating flow from a downspout.

As used herein, the expression “modulating flow” is intended to include restricting flow, reducing flow, occluding flow, obstructing flow, absorbing flow, the like, or any combination thereof. Without being bound by any particular theory, the present disclosure provides apparatuses and methods that advantageously reduce erosion of the soil and ground surface surrounding a downspout, particularly during heavy rain events.

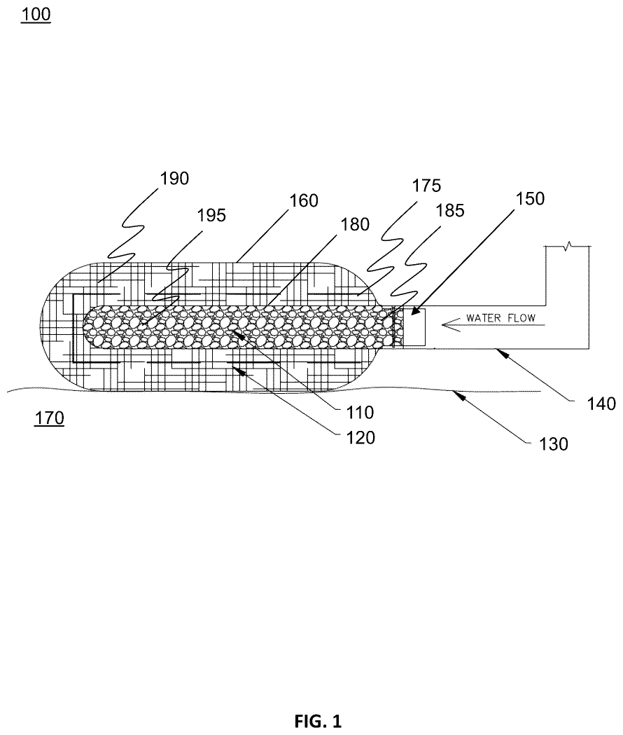

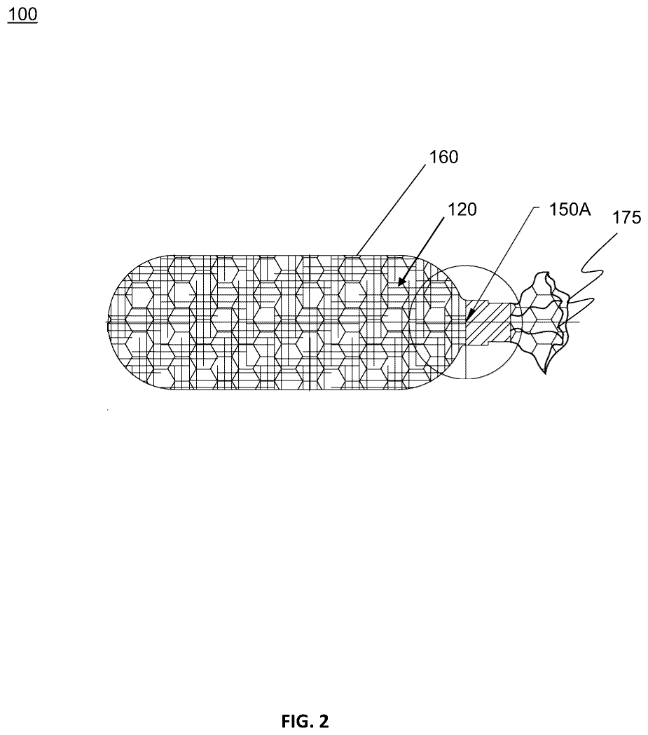

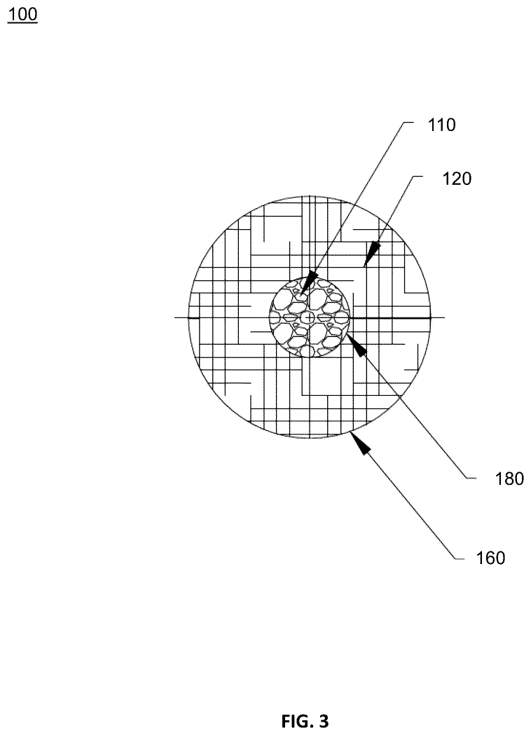

Embodiments of the present disclosure will now be described by reference to FIG. 1 to FIG. 8, which show representations of the apparatus and method according to the present disclosure.

FIG. 1 to FIG. 3 shows one example of an apparatus 100 that modulates flow volume and/or modulates a rate of flow of effluence from a downspout 140. Generally, an eaves trough and a downspout 140 are installed along a rooftop of a structure to convey rainwater away from the structure to prevent water damage. Rainwater sheet flows off the roof, into an eaves trough, and then into the downspout 140, which creates a concentrated flow at a point of egress from the downspout 140. The expression “sheet flow” may be used herein to downslope movement of water in the form of a thin and continuous film. The expression “concentrated flow” may be used herein to a substantially continuous discharge of water from a downspout 140 in a manner other than sheet flow. Concentrated flow may have a higher flow rate than sheet flow due to the cross-sectional flow area of the downspout being smaller than the rooftop.

Concentrated flow to a surface 130 containing erosion-susceptible soil 170 causes sediment to be carried onto sidewalks, curbs, asphalt, and/or storm water catch basins. Erosion caused by concentrated flow can be costly to developers and homeowners who would then have to repair the affected surface 130. The expression “erosion” may be used herein to the formation of channels or valleys in a surface 130 or susceptible soil 170 from the repeated, prolonged, or continuous flow of water along a path or paths. Concentrated flow may have a higher flow rate than sheet flow and, therefore, may enhance erosion as compared to sheet flow.

The apparatus 100 comprises at least a first outer shell 180 (which may also be referred to as a first layer) and a first matrix 110. In some embodiments of the present disclosure, the first outer shell 180 may comprise netting, mesh, webbing, lace, screening, tulle, veiling, or a combination thereof. The first outer shell 180 may be compostable, biodegradable, or a combination thereof. In some embodiments, the first outer shell 180 at least partially defines a first internal compartment 195 (which may also be referred to as an internal plenum).

In some embodiments of the present disclosure, the first matrix 110 may be provided within the first internal compartment 195 of the first outer shell 180. The first matrix 110 may comprise one or more partially absorbent materials. The one or more partially absorbent materials may be compostable, biodegradable, or a combination thereof. In a further embodiment, the one or more partially absorbent materials may comprise vermiculite, clay, sponge, activated carbon, soda lime, napkins, paper towels, anhydrous calcium chloride, allochroic silica gel, sodium polyacrylate, or a combination thereof. In a particular embodiment, the one or more partially absorbent materials comprises clay. In some embodiments of the present disclosure, the one or more partially absorbent materials comprises beads, balls, cubes, prisms, cuboids, pyramids, cones, or a combination thereof. In some embodiments of the present disclosure, the one or more partially absorbent materials comprise water absorbing bodies, for example clay balls.

In some embodiments of the present disclosure, a first opening 185 of the first outer shell 180 may be releasably connectible to an egress point of the downspout 140 by a releasable connector 150 wherein the first matrix 110 is configured to receive the flow from the downspout 140. The releasable connector 150 may comprise a zip tie, a hose clamp, a string, a rope, a rubber band, a downspout connector, a downspout adaptor, or a combination thereof. In an embodiment, the releasable connector 150 is compostable, biodegradable, or a combination thereof. In a particular embodiment, the releasable connector 150 comprises a downspout connector. In some embodiments of the present disclosure, the first opening 185 of the first outer shell 180 is provided to the downspout 140 by placing the releasable connector 150 inside the downspout 140 and then attaching the first outer shell 180 around the releasable connector 150 to secure the apparatus 100 to the downspout 140.

After adjustably connecting the apparatus 100 to the downspout 140, the flow from the downspout 140 passes through the first matrix 110. As the flow passes through the first matrix 110, the flow volume may be reduced—for example because at least some of the volume of the effluent is absorbed by the apparatus 100—and by extension, the rate of the concentrated flow along the surface 130 and the erosion-susceptible soil 170 is reduced. In some embodiments of the present disclosure, the first matrix 110 absorbs some of the volume of the effluent, thereby restricting the flow rate of effluent at the downspout 140.

The apparatus 100 may further comprise a second outer shell 160 (which may be referred to as a second layer) and a second matrix 120. The second outer shell 160 may comprise netting, mesh, webbing, lace, screening, tulle, veiling, or a combination thereof. The second outer shell 160 may be compostable, biodegradable, or a combination thereof. In some embodiments, the second outer shell 160 at least partially defines a second internal compartment 190 (which may also be referred to as a second internal plenum). The second outer shell 160 may be positioned about the first outer shell 180, so that the first outer shell 180 (and its contents) are at least partially housed within the second internal compartment 190.

In some embodiments of the present disclosure, the second matrix 120 may be provided within the second internal compartment 190 of the second outer shell 160. The second matrix 120 may comprise one or more fibrous materials. The one or more fibrous materials may be compostable, biodegradable, or a combination thereof. In a further embodiment, the one or more fibrous materials may comprise hemp, straw, cotton, flax, wool, jute, linen, silk, or a combination thereof. In a particular embodiment, the one or more fibrous materials comprises straw, hemp, or a combination thereof. In a further particular embodiment, the one or more fibrous materials comprises straw and hemp.

In some embodiments of the present disclosure, a second opening 175 of the second outer shell 160 may also be releasably connectible-via a second connector 150A-proximal the point of egress from the downspout 140 wherein the second matrix 120 is configured to receive at least some of the effluent flow from the first matrix 110. In a particular embodiment of the present disclosure, the second connector 150A may be a zip tie. In some embodiments of the present disclosure, the second opening 175 of the second outer shell 160 is operably connected to the downspout 140 by first wrapping the second outer shell 160 around the end of the downspout 140 and then providing the second connector 150A to the second outer shell 160 to secure the apparatus 100 to the downspout 140.

In some embodiments of the present disclosure, the flow rate from the downspout 140 is only partially reduced by passing the flow through the first matrix 110, allowing some flow of effluent, concentrated or otherwise, to pass through the first matrix 110. As the effluent passes through the apparatus 100, it is subjected to a flow path that is convoluted, which may also be referred to as a circuitous flow path. The convoluted flow path will also slow down the flow rate of the effluent. In some embodiments of the present disclosure, the flow rate from the downspout 140 is further reduced by passing the flow through the second matrix 120. Similar to the first matrix 110, the second matrix 120 may also define a convoluted flow path that will reduce the flow rate of the effluent passing therethrough. In some embodiments of the present disclosure, the flow rate of effluent is further reduced after passing through both the first matrix 110 and the second matrix 120, as compared to the effluent passing through the first matrix 110 alone. In some embodiments of the present disclosure, the concentrated flow of effluent is converted at least partially or completely into laminar flow after passing through one or both of the first matrix 110 and the second matrix 120. The expression “laminar flow” is used herein to the flow of water where all streamlines are straight and parallel. Laminar flow of effluent causes less or no erosion in surfaces 130 or erosion-susceptible soil 170 due to the reduction in flow rate, as compared to concentrated flow of effluent.

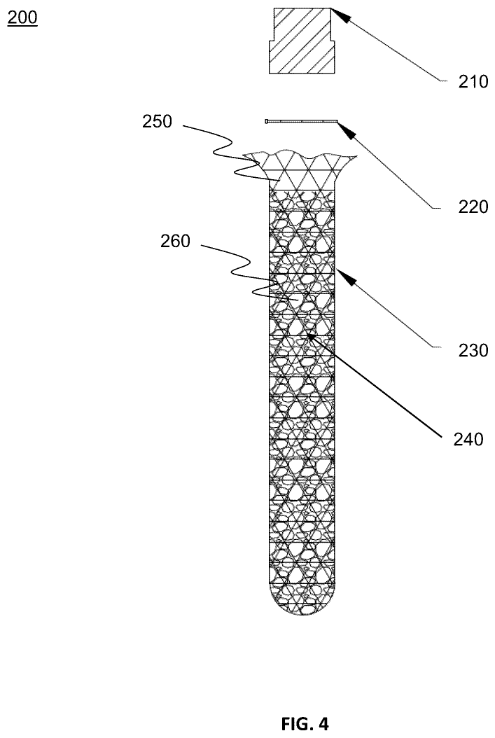

FIG. 4 shows a non-limiting example of an apparatus 200 that comprises a first outer shell 230, a first matrix 240, and a releasable connection 220, for example, a zip tie, and a downspout connector 210. In some embodiments of the present disclosure, the first matrix 240 is provided within a first internal compartment 260 of the first outer shell 230. In an embodiment, the apparatus 200 is adjustably connected to the downspout with the two connectors 210, 220.

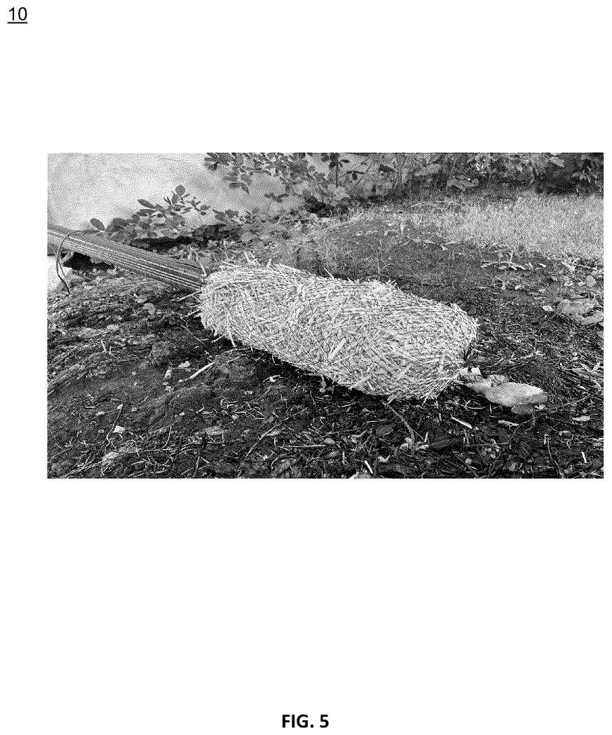

FIG. 5 is a photo that shows a non-limiting example of the apparatus 100 that is releasably connected to an egress point of a downspout to modulate effluent flow onto erosion-susceptible soil.

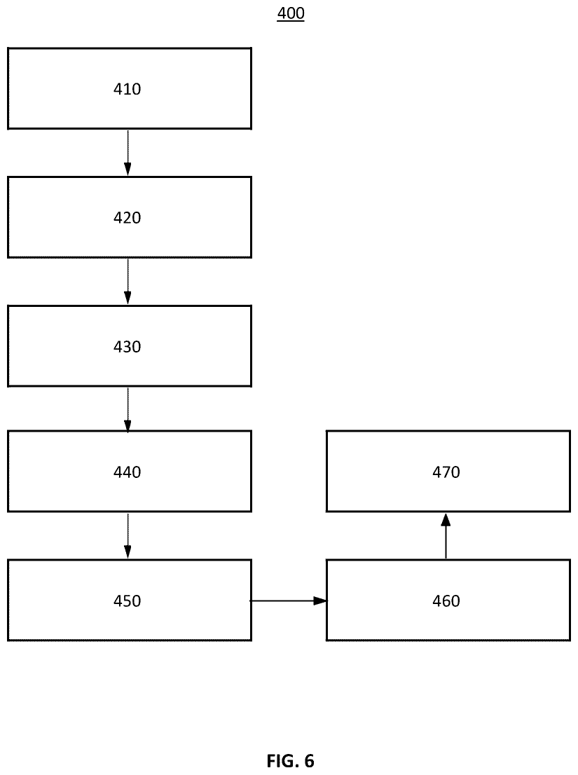

FIG. 6 shows a non-limiting example of a method 400 comprising a step of providing 410 an apparatus that is configured to modulate the flow of a downspout egress flow of water. In some embodiments of the present disclosure, the apparatus may comprise a first set of baffles or matrix within a first outer shell. Next, the method 400 includes a step of releasably connecting 420 a first opening of the apparatus to a downspout so that the downspout egress flow of water is received into the apparatus. The flow is then subjected to a step of passing 430 from point of egress from the downspout through the apparatus. In some embodiments, the method 400 also includes a step of providing 440 the second outer shell may be connected lengthwise to the apparatus of the first shell or it may be connected about the first outer shell. In some embodiments, the method 400 further includes a step of providing 450 a second set of baffles and/or matrix to a second internal compartment of the second outer shell. In a further embodiment, the method 400 includes a step of releasably connecting 460 a second opening of the second outer shell to the end of the first shell opposite to the downspout or proximal the egress point of the downspout. The method 400 further includes a step of passing 470 the downspout egress flow of water from within the first outer shell through the second outer shell. Each step of passing the downspout egress flow of water through the apparatus, in particular either through the matrix, the baffles or any combination thereof, the flow rate and/or volume of the downspout egress flow of water is modulated so as to reduce the erosive impact of the downspout egress flow of water.

In some embodiments of the method 400 of the present disclosure, the first matrix comprises one or more partially absorbent materials. In an embodiment of the method 400 of the present disclosure, the second matrix comprises one or more fibrous materials. In an embodiment of the method 400 of the present disclosure, the first outer shell and the second outer shell comprises netting, mesh, webbing, lace, screening, tulle, veiling, or a combination thereof. In a further embodiment of the method 400 of the present disclosure, the step of adjustably connecting 420 a first opening of the first outer shell to the downspout and adjustably connecting 460 a second opening of the second outer shell to the downspout comprises a zip tie, a hose clamp, a string, a rope, a rubber band, a downspout connector, a downspout adaptor, or a combination thereof. Without being bound by any particular theory, the step of passing 430, either alone or in combination with the step of passing 470 may result in absorbing at least some volume of the effluent, thereby reducing the volume of effluent proximal the point of egress, which reduces the flow rate of the effluent downstream of the point of egress. Furthermore or additionally, each of the steps 430 and/or 470 may further comprise a step of passing the effluent through a convoluted flow path created by the baffles, which may also or independently contribute towards restricting the flow rate of the effluent downstream of the point of egress.

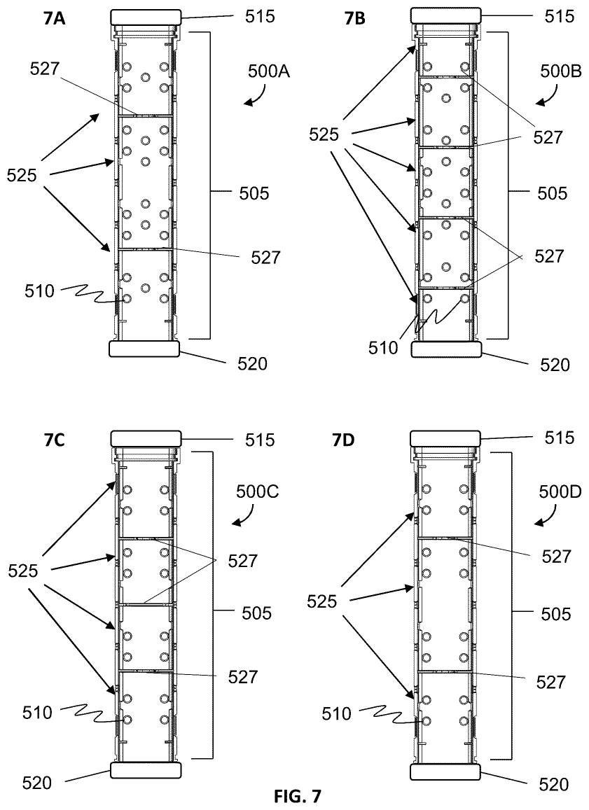

FIG. 7 shows several embodiments (FIGS. 7A, 7B, 7C, and 7D) of a non-limiting example of an apparatus (500A, 500B, 500C, 500D) that modulates flow volume and/or modulates a rate of flow of effluence from a downspout. The apparatus (500A, 500B, 500C, 500D) comprises a first outer shell 505 (which may also be referred to as a first layer), an end cap 515, and a connector 520.

The end cap 515 and the first outer shell 505 are operably connected to the downspout through the connector 520 (which is releasably connectible to said downspout), such that an internal plenum is defined starting from a first opening proximal to a point of egress of the downspout and ending at the end cap 515. The apparatus (500A, 500B, 500C, 500D) may be interconnected and releasably connected to the downspout by any suitable means. In some embodiments of the present disclosure, the apparatus (500A, 500B, 500C, 500D) is interconnected and/or releasably connected to the downspout through friction fit, fasteners, adhesives, the like, or any combination thereof. In a particular embodiment, the apparatus (500A, 500B, 500C, 500D) is interconnected and/or releasably connected to the downspout through friction fit. The friction fit may occur on either the outside or the inside of the apparatus (500A, 500B, 500C, 500D).

The apparatus (500A, 500B, 500C, 500D) comprises a rigid material. The rigid material may be any suitable material including plastic, metal, glass, wood, organic fibre, the like, or any combination thereof. In some embodiments of the present disclosure, the apparatus (500A, 500B, 500C, 500D) is 3D printed.

In some embodiments of the present disclosure, the first outer shell 505 comprises a plurality of holes 510 defined thereupon for passing the flow received from the downspout. The plurality of holes 510 may be provided in any shape, size, configuration, or position on the first outer shell 505. The first outer shell 505 may also define one or more baffles 527 that extend inwardly from the outer shell 505 to define a circuitous flow path through the apparatus so as to modulate the flow of water flowing therethrough. As will be appreciated by those skilled in the art, the specific design of the baffles 527 is not critical as to how the baffles 527 modulate the flow of downspout egress water; however, the baffles 527 will be of suitable size and dimensions so that in concert with the plurality of holes 510 the flow rate of the downspout egress water is modulated to a sufficient degree that erosion of the materials upon which the apparatus is positioned is substantially decreased. As will be appreciated by those skilled in the art, one or both of the matrices described hereinabove may be positioned within the first outer shell, within the circuitous path defined by the one or more baffles 527.

In some embodiments of the present disclosure, the plurality of holes 510 comprises about 2 holes, about 4 holes, about 8 holes, about 16 holes, or about 22 holes. In some embodiments of the present disclosure, the plurality of holes 510 comprises more than 16 holes. Without being bound by any particular theory, the dimensions of the plurality of holes 510 (i.e., shape, size, configuration, and/or position) may be chosen to modulate or maintain the flow of effluent from the downspout to a desired flow rate. While FIG. 7 shows embodiments of the apparatus (500A, 500B, 500C, 500D) having a plurality of holes 510, a person skilled in the art will appreciate that an apparatus comprising a single hole is contemplated by the present disclosure.

In some embodiments of the present disclosure, the first outer shell 505 comprises a plurality of sections 525. The plurality of sections 525 are interconnected through any suitable means. In some embodiments of the present disclosure, the interconnections between the plurality of sections 525 may only partially occlude the flow from passing. Without being bound by any particular theory, the number of interconnections provided through the number of the plurality of sections 525 may be used as a means for modulating the flow from the downspout. The plurality of sections 525 may comprise sections having the same length or a plurality of different lengths. In some embodiments of the present disclosure, the plurality of sections 525 comprises about 2 sections, about 3 sections, about 4 sections, or about 5 sections. In some embodiments of the present disclosure, the plurality of sections 525 comprises more than 5 sections. While FIG. 7 shows embodiments of the first outer shell 505 having a plurality of sections 525, a person skilled in the art will appreciate that an apparatus comprising a single monolithic section is contemplated as an embodiment of the present disclosure. While FIG. 7 shows baffles 527 as being positioned between the sections 525, that positioning is not required.

FIGS. 7A, 7B, 7C, and 7D show different embodiments of the apparatus (500A, 500B, 500C, 500D) having different numbers of holes 510 and the plurality of sections 525.

The connector 520 may comprise any shape or size suitable for connecting the first outer shell 505 with the downspout. The connector 520 may comprise a tube, a pipe, a channel, the like, or any combination thereof. In some embodiments of the present disclosure, the connector 520 comprises two mouths having the same size. In some embodiments of the present disclosure, the connector 520 comprises a graduated, tiered, or tapered body having mouths of different sizes. In some embodiments of the present disclosure, the apparatus (500A, 500B, 500C, 500D) comprises a plurality of first outer shells 505 that are operably connected to the downspout through a single connector 520. In such an embodiment, the connector 520 may comprise a first mouth for connecting to the point of egress of the downspout and a plurality of further mouths for connecting to the plurality of first outer shells 505. Without being bound by any particular theory, increasing the number of first outer shells 505 may be a means to further modulate the flow from the downspout by splitting the flow across the plurality of first outer shells 505.

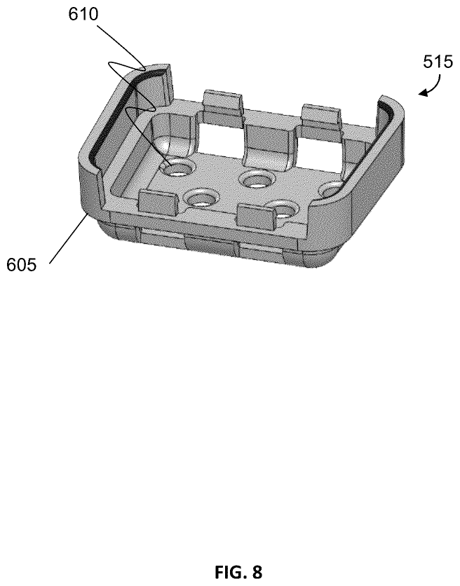

FIG. 8 shows a non-limiting example of the end cap 515 shown in FIG. 7. The end cap 515 comprises a body 605 having one or more holes 610 disposed thereupon.

1. An apparatus for modulating an egress flow of fluid from a downspout, the apparatus comprising: a first shell that is releasably connectible proximal to a point of egress from the downspout, the first layer defining a first opening and an internal plenum, and wherein the first opening is configured to receive and direct the egress flow through the internal plenum, wherein the internal plenum is configured to modulate at least a portion of the egress flow as it passes through the internal plenum.

2. The apparatus of claim 1, further comprising a first matrix at least partially housed within the internal plenum, the first matrix comprising a first material that is configured to absorb at least a portion of the egress flow.

3. The apparatus of claim 2, further comprising a second layer positioned within the first matrix for at least partially housing an internal compartment, the second layer having a second opening that is releasably connectible to the point of egress from the downspout.

4. The apparatus of claim 3, further comprising a second matrix within the second internal component, wherein the second matrix comprises a fibrous material.

5. The apparatus of claim 2, wherein the first material comprises vermiculite, clay, sponge, activated carbon, soda lime, napkins, paper towels, anhydrous calcium chloride, allochroic silica gel, sodium polyacrylate, or any combination thereof.

6. The apparatus of claim 4, wherein the fibrous material comprises hemp, straw, cotton, flax, wool, jute, linen, silk, or any combination thereof.

7. The apparatus of claim 4, wherein the first material and the second material are compostable, biodegradable, or a combination thereof.

8. The apparatus of claim 1, wherein the first layer comprises netting, mesh, webbing, lace, screening, tulle, veiling, or any combination thereof.

9. The apparatus of claim 3, wherein the second layer comprises netting, mesh, webbing, lace, screening, tulle, veiling, or any combination thereof.

10. The apparatus of claim 3, wherein the first layer and the second layer are compostable, biodegradable, or any combination thereof.

11. The apparatus of claim 1, wherein the first shell is made of a rigid material that defines the first opening and the internal plenum, wherein the internal plenum defines one or more baffles that define a circuitous flow path for directing the egress flow therethrough.

12. The apparatus of claim 11, wherein the rigid material comprises plastic, metal, glass, wood, organic fibre, or any combination thereof.

13. The apparatus of claim 1, wherein the apparatus is releasably connectible to the downspout by a zip tie, a hose clamp, a string, a rope, a rubber band, a downspout connector, a downspout adaptor, or any combination thereof.

15. The apparatus of claim 1, wherein the apparatus is releasably connectible to the downspout by a compostable material, a biodegradable material, or a combination thereof.

16. A method for modulating an egress flow from a downspout, the method comprising:
(a) providing the apparatus of claim 1; and
(b) releasably connecting the apparatus proximal to an egress point of the downspout wherein the internal plenum is configured to modulate at least a portion of the egress flow.
